(19) United States
(12) Patent Application Publication
(10) Pub. No.: US 2014/0373027 A1
(43) Pub. Date: Dec. 18, 2014

(54) APPLICATION LIFETIME MANAGEMENT

(71) Applicant: Microsoft Corporation, Redmond, WA (US)

(72) Inventors: Hari Pulapaka, Redmond, WA (US); Arun Upadhyaya Kishan, Kirkland, WA (US); Pedro Miguel Teixeira, Redmond, WA (US); Alex Bendetov, Redmond, WA (US); Yaou Wei, Redmond, WA (US); Michael Hans Krause, Redmond, WA (US)

(21) Appl. No.: 13/918,363

(22) Filed: Jun. 14, 2013

(51) Int. Cl. G06F 9/48

(52) U.S. Cl. CPC G06F 9/485
USPC 718/106

(57) ABSTRACT

One or more techniques and/or systems are provided for facilitating lifetime management of dynamically created child applications and/or for managing dependencies between a set of applications of an application package. In an example, a parent application may dynamically create a child application. A child lifetime of the child application may be managed independently and/or individually from lifetimes of other applications with which the child application does not have a dependency relationship. In another example, an application within an application package may be identified as a dependency application that may provide functionality depended upon by another application, such as a first application, within the application package. A dependency lifetime of the dependency application may be managed according to a first lifetime of the first application. In this way, lifetimes (e.g., initialization, execution, suspension, termination, etc.) of applications may be managed to take into account dynamically created child applications and/or dependency relationships.

### BACKGROUND

Many computing environments, such as operating systems, may manage resources and/or applications through various models. For example, an operating system of a mobile device (e.g., a tablet device, a mobile phone, etc.) may actively execute an application that is in the foreground (e.g., visible to a user), and may suspend the application when the application is not in the foreground (e.g., not visible to the user, such as in the background). When the application is suspended or resumed for execution, any processes associated with the application may be suspended or resumed as a single unit. For example, a productivity application suite may comprise a mail application, a calendar application, a chat application, and a shared server application. If the mail application is suspended, then the calendar application, the chat application, and the shared server application may be suspended along with the mail application. In this way, lifetime management of applications (e.g., resource management, initialization, execution, suspension, termination, and/or management of other aspects of an application) may reduce power consumption and/or allow for computing environments to execute on a variety of devices such as low resource devices (e.g., a mobile device).

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for facilitating lifetime management of dynamically created child applications and/or for managing dependencies between a set of applications of an application package during lifetime management of the set of applications are provided herein.

In some embodiments of facilitating lifetime management of dynamically created child applications, a parent application may dynamically create a child application during execution. For example, a browser application may dynamically create a first child browser tab application (e.g., corresponding to a first browser tab user interface hosted within a browser application user interface), a second child browser tab application (e.g., corresponding to a second browser tab user interface hosted within the browser application user interface), and/or other child applications during execution of the browser application. The browser application may notify a lifetime management component (e.g., an operating system component configured to manage resource access, initialization, execution, suspension, termination, and/or other aspects of applications) that a first child lifetime of the first child browser tab application is to be managed independently from lifetimes of applications with which the first child browser tab application does not have a dependency relationship. For example, presuming that the first child browser tab application does not have a dependency relationship with the second child browser tab application, the first child lifetime may be managed independently from a second child lifetime of the second child browser tab application (e.g., if the user switches from viewing the first browser tab user interface to the second browser tab user interface, then the first child browser tab application may be suspended and the second child browser tab application may be executed) and/or from a parent lifetime of the browser application (e.g., the browser application may be a parent “shared” application with respect to the first and/or second browser tab applications as child applications (e.g., if the first and/or second browser tab applications are executing, then the browser application may be executing), and thus the browser application may specify to the operating system which dynamically created browser tab applications or other child applications may be suspended and/or resource managed). In an example, the operating system may override a request or specification from a parent application to transition a child application into a particular state (e.g., a suspended state, an execution state, etc.). For example, the operating system may utilize other policies and/or information associated with other system components to determine how to treat a child application (e.g., even though the parent application may specify that a child application is to be suspended, the operating system may retain the child application in an executing state based upon a system component currently interacting with, utilizing, etc. the child application). In this way, dynamically created child applications may benefit from independent execution and/or resource management policies, which may mitigate resource consumption otherwise consumed by unnecessary execution of applications.

In some embodiments of managing dependencies between a set of applications of an application package, an application package comprising a set of applications may be identified (e.g., a productivity package comprising a mail application, a chat application, a calendar application, and a shared server application). A dependency application may be identified within the set of applications based upon the dependency application being depended upon by one or more applications within the set of applications, such as a first application. For example, the shared server application may be identified as a dependency application based upon the mail application, the chat application, and/or calendar application consuming data storage functionality provided by the shared server application. A dependency relationship between the dependency application and the first application may be defined such that a dependency lifetime of the dependency application is managed according to a first lifetime of the first application (e.g., if any application that depends upon the shared server application is executing, then the shared server application may be executed; if all applications that depend upon the shared server application are suspended, then the shared server application may be suspended; etc.). In an example, the dependency application may have dependency relationships with multiple applications within the application package, and thus the dependency lifetime of the dependency application may be tied to lifetimes of such applications. Otherwise, lifetimes of respective applications, not associated with a dependency relationship (e.g., applications that do not provide functionality relied upon by other applications, and are thus not dependency applications), within the set of applications may be independently managed. For example, if the mail application is suspended, then the chat application may continue to execute because lifetimes of such applications are independently and/or individually managed (e.g., even though such applications are comprised within the application package). In this way, applications may be independently managed (e.g., for improved power consumption) while taking into account dependencies between such applications (e.g., so that a dependency applications is available to provide functionality depended upon by another application).

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of facilitating lifetime management of a dynamically created child application.

FIG. 2 is a component block diagram illustrating an exemplary system for facilitating lifetime management of dynamically created child applications.

FIG. 3A is an illustration of an example of independently suspending a child application dynamically created by a parent application.

FIG. 3B is an illustration of an example of unsuspending a suspended child application based upon identifying a communication between an application and the suspended child application.

FIG. 4 is a component block diagram illustrating an exemplary system for facilitating lifetime management of dynamically created child applications.

FIG. 5 is a flow diagram illustrating an exemplary method of managing dependencies between a set of applications of an application package during lifetime management of the set of applications.

FIG. 6 is a component block diagram illustrating an exemplary system for managing dependencies between a set of applications of an application package during lifetime management of the set of applications.

FIG. 7 is an illustration of an exemplary computer readable medium wherein processor-executable instructions configured to embody one or more of the provisions set forth herein may be comprised.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide an understanding of the claimed subject matter. It may be evident, however, that the claimed subject matter may be practiced without these specific details. In other instances, structures and devices are illustrated in block diagram form in order to facilitate describing the claimed subject matter.

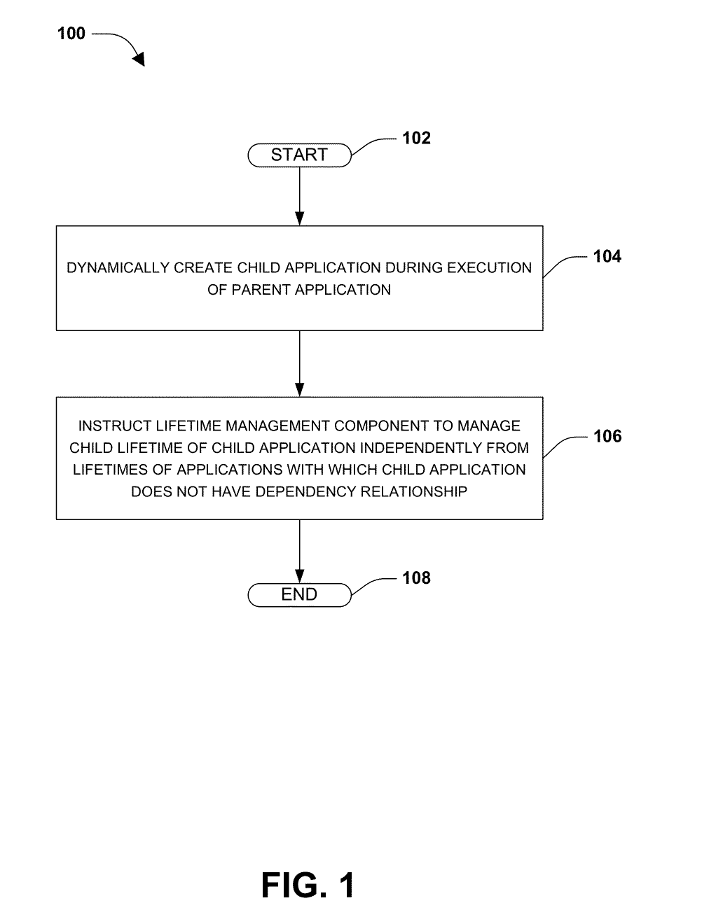

An embodiment of facilitating lifetime management of a dynamically created child application is illustrated by an exemplary method 100 of FIG. 1. At 102, the method starts. Lifetime management of an application may correspond to managing resource access, initialization, execution, suspension, termination, and/or other operational functionality of an application. In an example, an operating system may be configured to individually manage lifetimes of applications hosted by the operating system (e.g., a background application may be suspended, while a foreground application may be executing, to preserve power consumption that may otherwise be consumed by execution of the background application). Because a parent application may dynamically create a child application (e.g., one or more child processes) that may be initially grouped with the parent application (e.g., within a job object or other relationship indicating that a child process is managed with a parent process) during execution, it may be advantageous to identify the child application for separate lifetime management from other applications that do not share a dependency with the child application (e.g., otherwise, the lifetime of the child application may be tied to the parent application, which may result in inefficient resource utilization).

Accordingly, a child application may be dynamically created during execution of a parent application, at 104. For example, a photo sharing parent application may create a photo editing child application (e.g., a user may open a photo editing user interface of a photo sharing application). At 106, a lifetime management component (e.g., configured to manage lifetimes of applications) may be instructed to manage a child lifetime of the child application independently from lifetimes of application with which the child application does not have a dependency relationship. In an example, the photo editing child application may not have a dependency relationship with the photo sharing parent application, and thus a child lifetime of the photo editing child application may be managed independently from a parent lifetime of the photo sharing parent application (e.g., the photo editing child application may be initialized, executed, suspended, and/or terminated regardless of whether the photo sharing parent application is initialized, executed, suspended, and/or terminated). In this way, management of the photo editing child application may take advantage of separate system execution and/or resource management policies. In an example, if the user is currently interacting with the photo editing child application and not the photo sharing parent application, then the photo editing child application may be executing while the photo sharing parent application may be suspended. Suspension of the photo sharing parent application while not in use may conserve power consumption, which may improve performance of low resource devices such as tablets and/or mobile devices. In another example, a document application (e.g., a parent application) may create a separate dynamic process to view documents, such as a viewer process (e.g., a child application). When the viewer process is executing, the document application may be executing in order to provide various services to the viewer process (e.g., the parent application may provide various services to the child application). However, dynamically created children (e.g., the viewer process, a spell checker process, and/or other child applications created by the document application) may be treated as mutually exclusive, and thus may be suspended and/or resource managed independently.

In an example, the child application may have a first dependency relationship with a first application. For example, the photo sharing parent application may specify that the photo editing child application has a first dependency relationship with a drawing creation application based upon the drawing creation application depending upon photo editing functionality provided by the photo editing child application. The lifetime management component may be instructed to manage the child lifetime of the child application according to a first lifetime of the first application based upon the first dependency relationship (e.g., the child lifetime of the photo editing child application may be tied to a first lifetime of the drawing creation application). For example, the photo editing child application may be initialized, executed, suspended, and/or terminated based upon a current state of the drawing creation application (e.g., initialization, execution, suspension, termination, etc.). In an example, a dependency graph specifying one or more dependencies between applications may be maintained. A new dependency may be created within the dependency graph based upon the first dependency relationship. In this way, the lifetime management component may utilize the dependency graph to determine which applications have dependency relationships with other applications.

In an example, an application may attempt to communicate with the child application while the child application is in a suspended state. Responsive to identifying such communication, the child application may be transitioned form the suspended state to an execution state for communication with the application. For example, responsive to the photo sharing parent application sending an upload photo instruction to the photo editing child application while the photo editing child application is in the suspended state, the photo editing child application may be transitioned into an execution state to receive the instruction. In an example, the photo sharing parent application may specify state transition requests (e.g., “hints”) to the operating system that state transitions are to be performed. Accordingly, while the photo sharing parent application is active, the operating system may carry out (e.g., “honor”) the state transition requests. However, if the photo sharing parent application is not active, then the operating system may ignore the state transition requests, and may manage the photo editing child application in a default or desired manner (e.g., place the photo editing child application into an inactive state). In this way, a parent application may specify state transition directions to the operating system regarding a dynamically created child application, for example, which may be taken into account (e.g., along with other policies and/or information from other components) by the operating system in determining how to treat the child application (e.g., suspend, execute, etc. the child application).

In an example, a parent application may dynamically create one or more child applications, such as a second child application, during execution. The lifetime management component may be instructed to manage a second child lifetime of the second child application independently from lifetimes of applications with which the second child application does not have a dependency relationship. For example, the second child lifetime may be managed independently from the child lifetime of the child application and/or the parent lifetime of the parent application. In this way, child lifetimes of dynamically created child applications may be independently and/or individually managed. At 108, the method ends.

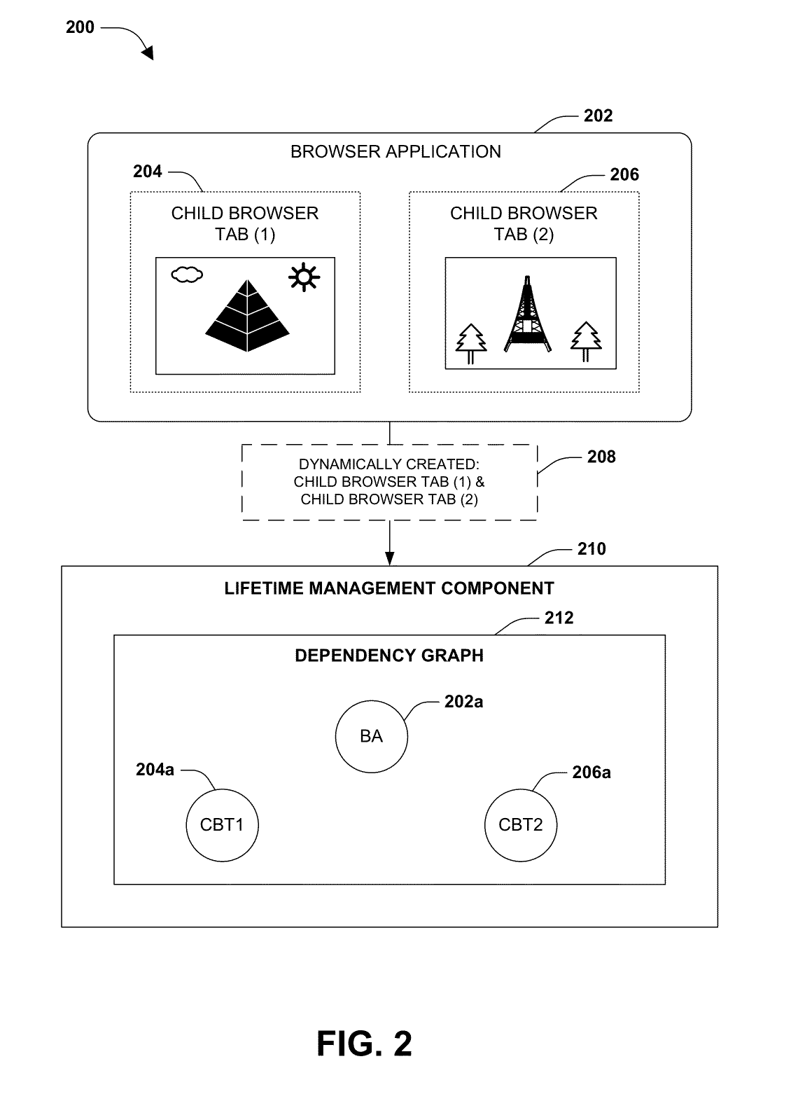

FIG. 2 illustrates an example of a system 200 configured for facilitating lifetime management of dynamically created child applications. The system 200 may comprise a lifetime management component 210 associated with a computing environment of a computing device (e.g., a tablet device, a mobile device, a desktop device, etc.). The computing environment, such as an operating system, may host one or more applications, such as a browser application 202 configured to display websites and/or other content. The lifetime management component 210 may be configured to manage lifetimes of such applications (e.g., resource access, initialization, execution, suspension, termination, or other operational states of an application). During execution, the browser application 202 (e.g., a parent application) may dynamically create one or more child applications (e.g., one or more child processes). For example, the browser application 202 may dynamically create 208 a first child browser tab 204 (e.g., a first browser tab interface displaying a vacation news article) and/or a second child browser tab 206 (e.g., a second browser tab interface displaying a social network user shared image).

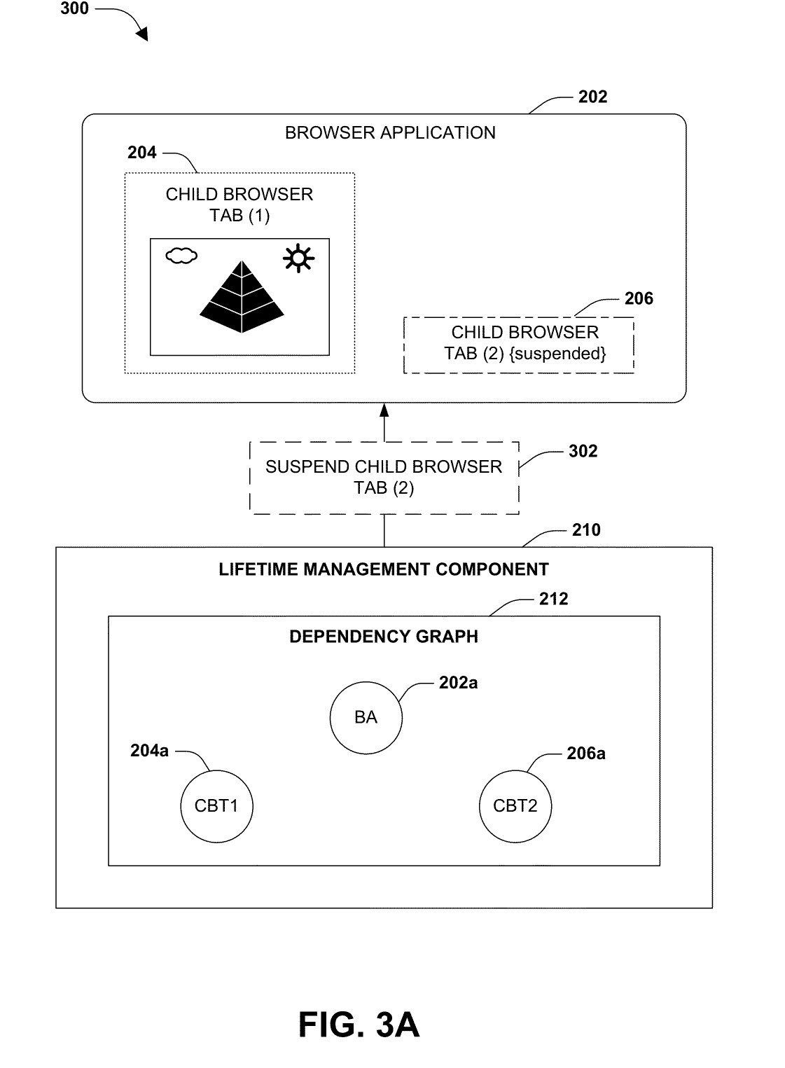

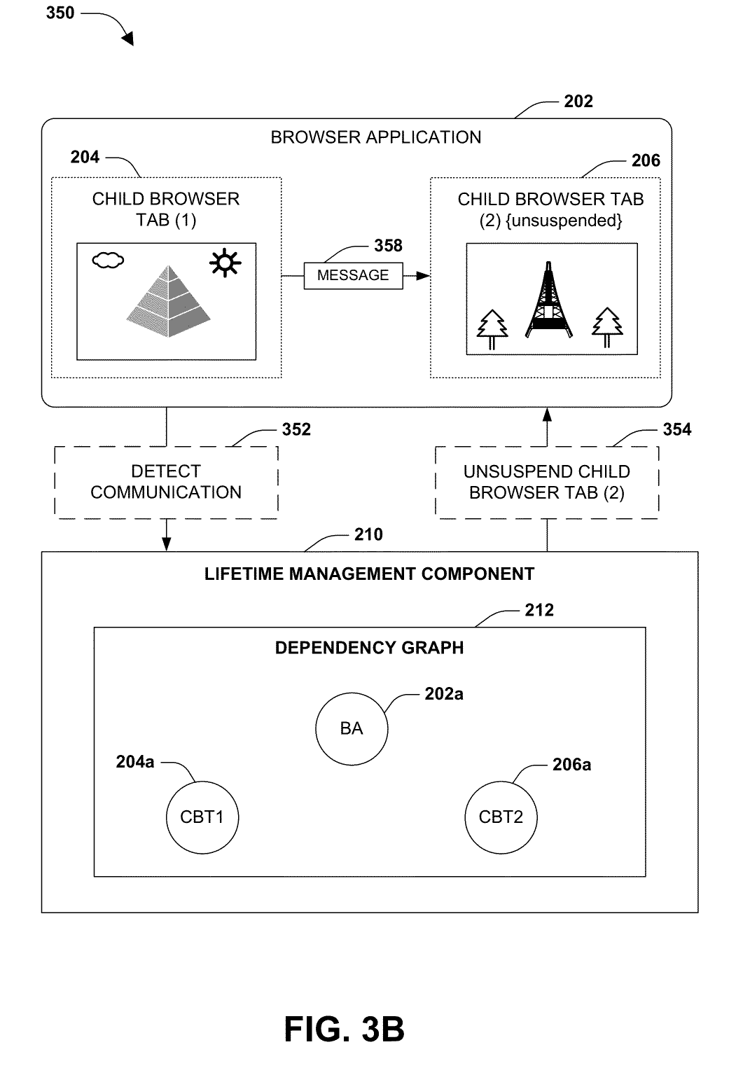

The lifetime management component 210 may be configured to identify the dynamic creation 208 of the first child browser tab 204 and the second child browser tab 206. In an example, the lifetime management component 210 may determine that the first child browser tab 204 and the second child browser tab 206 are to be independently and/or individually managed (e.g., the lifetime component 210 may receive an instruction through an API, exposed to the browser application 202, that the first child browser tab 204 and the second child browser tab 206 are to be independently and/or individually managed where no dependency relationship exists). That is, a first child lifetime of the first child browser tab 204 may be managed independently from the browser application 202 (e.g., a parent lifetime of the browser application 202) and/or the second child browser tab 206 (e.g., a second child lifetime of the second child browser tab 206) because the first child browser tab 204 does not have a dependency relationship with the browser application 202 and/or the second child browser tab 206. The second child lifetime of the second child browser tab 206 may be managed independently from the browser application 202 (e.g., the parent lifetime of the browser application 202) and/or the first child browser tab 204 (e.g., the first child lifetime of the first child browser tab 204) because the second child browser tab 206 may not have a dependency relationship with the browser application 202 and/or the first child browser tab 204. In this way, the browser application 202, the first child browser tab 204, and/or the second child browser tab 206 may benefit from separate execution and/or resource management policies, as opposed to being tied to a parent lifetime of the browser application 202. For example, the second child browser tab 206 may be suspended (e.g., responsive to being minimized into a background state by a user) while the browser application 202 remains in an execution state, as opposed to the second child browser tab 206 being forced to continue executing merely because the browser application 202 (e.g., as the parent application) is still executing (e.g., FIG. 3A). Independent and/or individual management of child lifetimes of dynamically created child applications may mitigate unnecessary memory consumption, power consumption, and/or other resource utilization (e.g., where mitigating unnecessary resource utilization promotes efficient operation of the computing environment on low resource devices, such as a mobile device).

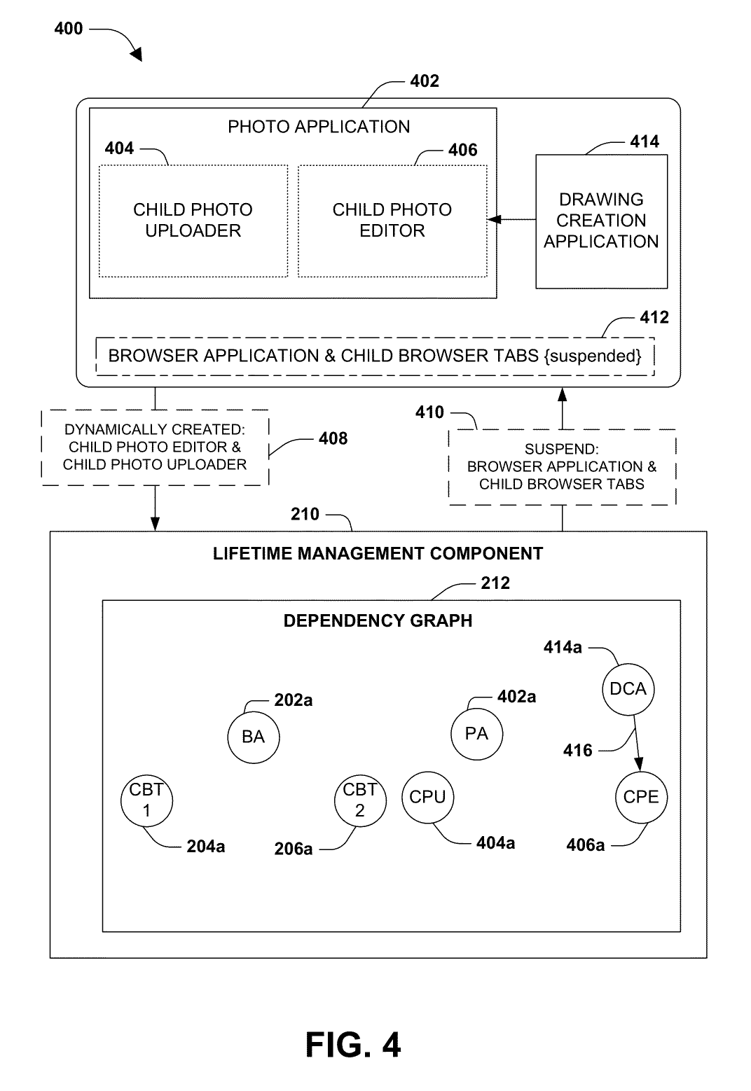

In an example, the lifetime management component 210 may maintain a dependency graph 212 specifying one or more dependencies between applications. The dependency graph 212 may comprise one or more nodes representing applications (e.g., a first node 202a representing the browser application 202, a second node 204a representing the first child browser tab 204, and a third node 206a representing the second child browser tab 206. An edge (e.g., a direct edge) may connect two nodes that representing applications having a dependency relationship (e.g., edge 416 representing a dependency relationship between a drawing creation application 414 and a child photo editor 406 based upon the drawing creation application 414 relying upon photo editor functionality provided by the child photo editor 406, as illustrated in FIG. 4). Because the browser application 202, the first child browser tab 204, and the second child browser tab 206 do not have dependency relationships and are thus independently and/or individually managed, no edges connect the first node 202a, the second node 204a, and/or the third node 206a.

FIG. 3A illustrates an example 300 of independently suspending a child application dynamically created by a parent application. In an example, a browser application 202 (e.g., the parent application) may have dynamically created a first child browser tab 204 and a second child browser tab 206 whose child lifetimes are independently managed by a lifetime management component 210 (e.g., FIG. 2). For example, the browser application 202, the first child browser tab 204, and the second child browser tab 206 may be in an execution state. The second child browser tab 206 may be minimized by a user. The lifetime management component 210 may consult a dependency graph 212 to determine whether the second child browser tab 206 has any dependency relationships with other applications (e.g., which may be illustrated by edges between nodes representing applications). Because the second child browser tab 206 does not have any dependency relationships, a second child lifetime of the second child browser tab 204 may be independently managed from lifetimes of other applications. For example, responsive to the second browser tab 206 being minimized, the lifetime management component 210 may suspend 302 the second child browser tab 260 irrespective of a current state of the browser application 202 (e.g., the parent application) and/or a current state of the first child browser tab 204 (e.g., the browser application 202 and/or the first child browser tab 204 may still be executing during suspension of the second child browser tab 206). In this way, resource consumption may be mitigated by suspending the second child browser tab 206, as opposed to forcing the second child browser tab 206 to remain executing based upon the browser application 202 (e.g., the parent application) and/or the first child browser tab 204 still executing.

FIG. 3B illustrates an example 350 of unsuspending a suspended child application based upon identifying a communication between an application and the suspended child application. In an example, a browser application 202 (e.g., the parent application) may have dynamically created a first child browser tab 204 and a second child browser tab 206 whose child lifetimes are independently managed by a lifetime management component 210 (e.g., FIG. 2). For example, the browser application 202, the first child browser tab 204, and the second child browser tab 206 may have been in an execution state. Responsive to a user minimizing the second child browser tab 206, the lifetime management component 210 may have placed the second child browser tab 206 into a suspended state (e.g., FIG. 3A).

The lifetime management component 210 may be configured to detect communication between applications so that a suspended application may be transitioned into an execution state for communication. For example, the lifetime management component 210 may detect 352 a message 358 being sent from the first child browser tab 204 to the second child browser tab 206 while the second child browser tab 206 is in the suspended state. The lifetime management component 210 may transition (e.g., unsuspend 354) the second child browser tab 206 from the suspended state to an execution state so that the second child browser tab 206 may receive the message 358.

FIG. 4 illustrates an example of a system 400 for facilitating lifetime management of dynamically created child applications. The system 400 may comprise a lifetime management component 210 associated with a computing environment of a computing device (e.g., a tablet device, a mobile device, a desktop device, etc.). The computing environment, such as an operating system, may host one or more applications, such as a browser application 202 configured to display websites and/or other content. The lifetime management component 210 may be configured to manage lifetimes of such applications (e.g., resource access, initialization, execution, suspension, termination, etc.). In an example, the lifetime management component 210 may maintain a dependency graph 212 specifying one or more dependencies between applications (e.g., represented by edges between nodes, such as an edge 416). For example, a first node 202a may represent a browser application (e.g., a parent application), a second node 204a may represent a first child browser tab (e.g., a first child application dynamically created by the parent application), and a third node 206a may represent a second child browser tab (e.g., a second child application dynamically created by the parent application) (e.g., FIG. 2). Because the browser application, the first child browser tab, and the second child browser tab do not have dependency relationships (e.g., no edges between 202a, 204a and/or 206a), the lifetime management component 210 may independently and/or individually manage lifetimes of such applications. In an example, the lifetime management component 210 may suspend 410 the browser application and the child browser tabs due to inactivity (e.g., the browser application and the child browser tabs may be minimized by a user when the user launches a photo application 402), thus resulting in the browser application and the child browser tabs in the suspended state 412.

In an example, the photo application 402 may dynamically create one or more child applications, such as a child photo uploader 404 (e.g., an interface through which the user may upload one or more photos to a photo sharing service) and/or a child photo editor 406 (e.g., an interface through which the user may edit photos). The lifetime management component 210 may be configured to identify the dynamic creation 408 of the child photo uploader 404 and the child photo editor 406. In an example, the lifetime management component 210 may determine that the child photo uploader 404 is to be independently and/or individually managed (e.g., the lifetime management component 210 may receive an instruction through an API, exposed to the photo application 402, that the child photo uploader 404 is to be independently and/or individually managed where no dependency relationship exists). That is, a photo uploader child lifetime of the child photo uploader 404 may be managed independently from the photo application 402 (e.g., a parent application for the child photo uploader 404), the child photo editor 406, a drawing creation application 414 hosted within the computing environment, the browser application, the first child browser tab, and/or the second child browser tabs because the child photo uploader 404 does not have dependency relationships with such applications.

In an example, the lifetime management component 210 may determine that the child photo editor 406 has a dependency relationship with the drawing creation application 414 based upon the drawing creation application 414 relying upon photo editing functionality provided by the child photo editor 406. Accordingly, the lifetime management component 210 may manage a photo editor child lifetime of the child photo editor 406 according to a lifetime of the drawing creation application 414. For example, the child photo editor 406 may be initialized based upon initialization of the drawing creation application 414, executed based upon execution of the drawing creation application 414, suspended based upon suspension of the drawing creation application 414, and/or terminated based upon termination of the drawing creation application 414.

In an example, the lifetime management component 210 may represent the photo application 402 as a fourth node 402a, the child photo uploader 404 as a fifth node 404a, the child photo editor 406 as a sixth node 406a, and the drawing creation application 414 as a seventh node 414a within the dependency graph 212. Because the photo application 402 and the child photo uploader 404 do not have dependency relationships with other applications, no edges connect the fourth node 402a, representing the photo application 402, and/or the fifth node 404a, representing the child photo uploader 404, to other nodes within the dependency graph 212. Because the child photo editor 406 has a dependency relationship with the drawing creation application 414, a new dependency (e.g., represented by edge 416 connecting the sixth node 406a, representing the child photo editor 406, and the seventh node 414a representing the drawing creation application 414) may be created within the dependency graph 212. In this way, the lifetime management component 210 may utilize the dependency graph 212 to manage lifetimes of dynamically created applications.

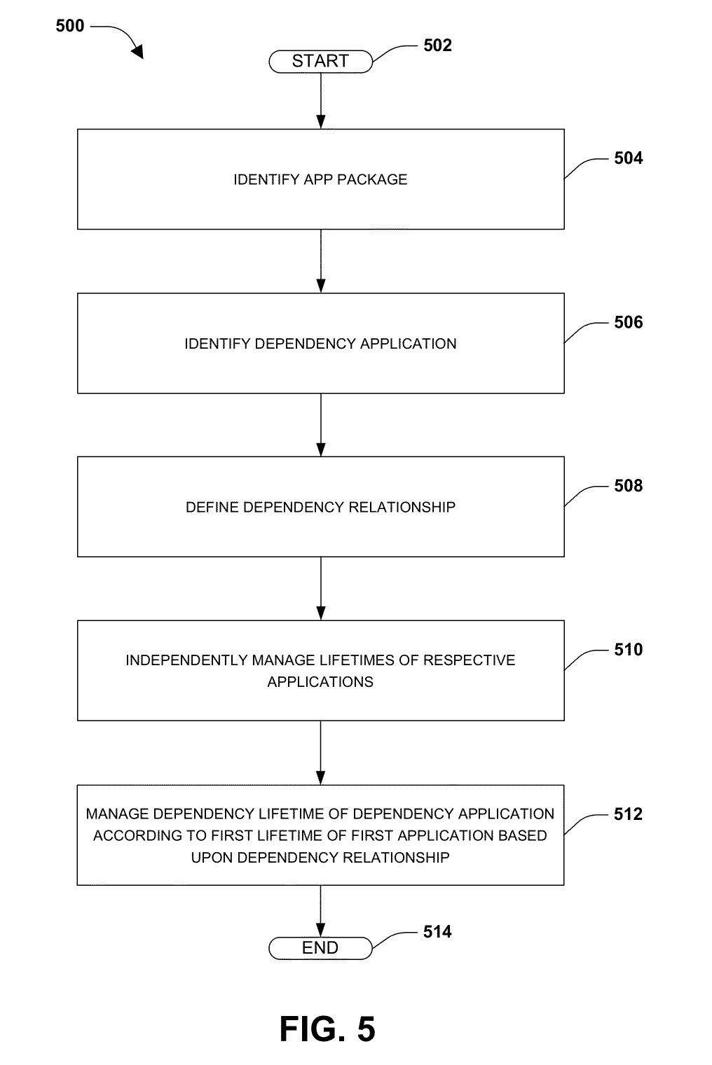

An embodiment of managing dependencies between a set of applications of an application package during lifetime management of the set of applications is illustrated by an exemplary method 500 of FIG. 5. An application package may comprise one or more applications that may be distributed, downloaded, and/or installed as a set of applications (e.g., as a single unit). For example, a productivity application package may comprise a chat application, a mail application, a calendar application, a shared server application (e.g., configured to provide storage functionality for the chat application, the mail application, and the calendar application) and/or other applications. With the ability to independently and/or individually manage applications within the application package, it may be advantageous to identify dependencies between applications so that applications providing functionality relied upon by other applications are managed together (e.g., a lifetime of the shared server application may be tied to lifetimes of the chat application, the mail application, and the calendar application so that the storage functionality provided by the shared server application is available to such applications).

At 502, the method starts. At 504, an application package comprising a set of applications may be identified (e.g., the productivity package may be identified by a lifetime management component based upon the productivity package being downloaded to a computing environment of a computing device, such as a tablet device, a mobile device, a desktop device, etc.). At 506, a dependency application within the set of application may be identified based upon the dependency application being depended upon (e.g., relied upon) by one or more applications, such as a first application, within the set of applications. For example, the shared server application may be identified as a dependency application because the chat application, the mail application, and the calendar application utilize storage functionality provided by the shared server application. In an example, the dependency application may be identified based upon the dependency application being a shared server and/or an infrastructure component (e.g., a notification infrastructure component that provides notification services associated with calendar events, chat messages, new emails, etc.). In another example, the dependency application may be identified based upon the dependency application not corresponding to a user interface (e.g., a user interface, such as the mail application, may have a higher likelihood of relying upon services provided by non-user interface services or infrastructure components). In another example, a service provided by an application may be evaluated to determine whether the application is a dependency application. In another example, an application may explicitly declare that the application is a dependency application (e.g., through a static declaration within application package installation data).

At 508, a first dependency relationship between the dependency application and the first application, such as the mail application, may be defined (e.g., and/or dependency relationships with other applications within the set of applications). For example, a dependency graph may be maintained. The dependency graph may specify one or more dependencies between applications, such as applications within the set of applications. A new dependency may be created within the dependency graph based upon the first dependency relationship (e.g., an edge, representing the first dependency relationship, may be created to connect a first node, representing the mail application, with a second node representing the shared server application). In an example, a second dependency relationship between the dependency application and a second application, such as the chat application, within the set of applications may be defined. A second new dependency may be created within the dependency graph based upon the second dependency relationship (e.g., a second edge, representing the second dependency relationship, may be created to connect a third node, representing the chat application, with the second node representing the shared server application).

At 510, lifetimes of respective applications, not associated with a dependency relationship (e.g., an application that is not a dependency application, and thus not depended upon by another application), within the set of applications may be independently and/or individually managed. For example, the chat application may not provide functionality that may be depended upon by other applications, and thus the chat application may be initialized, executed, suspended, and/or terminate independently of other applications. Thus, if the calendar application is active (e.g., currently being utilized by a user), then the chat application may be suspended (e.g., due to a lack of interaction with the calendar application) to conserve resource consumption and/or improve battery life. In this way, the chat application may be managed independently from the calendar application even though the application package comprises both the chat application and the calendar application.

At 512, a dependency lifetime of the dependency application may be managed according to a first lifetime of the first application based upon the first dependency relationship. For example, the shared server application may be initialized based upon initialization of the mail application (e.g., and/or other applications that depend upon functionality provided by the shared server application), executed based upon execution of the mail application (e.g., and/or other applications that depend upon functionality provided by the shared server application), suspended based upon suspension of the mail application (e.g., and/or other applications that depend upon functionality provided by the shared server application), and/or terminated based upon termination of the mail application (e.g., and/or other applications that depend upon functionality provided by the shared server application). In this way, the shared server application may be available to applications that rely upon functionality provided by the shared server application. At 514, the method ends.

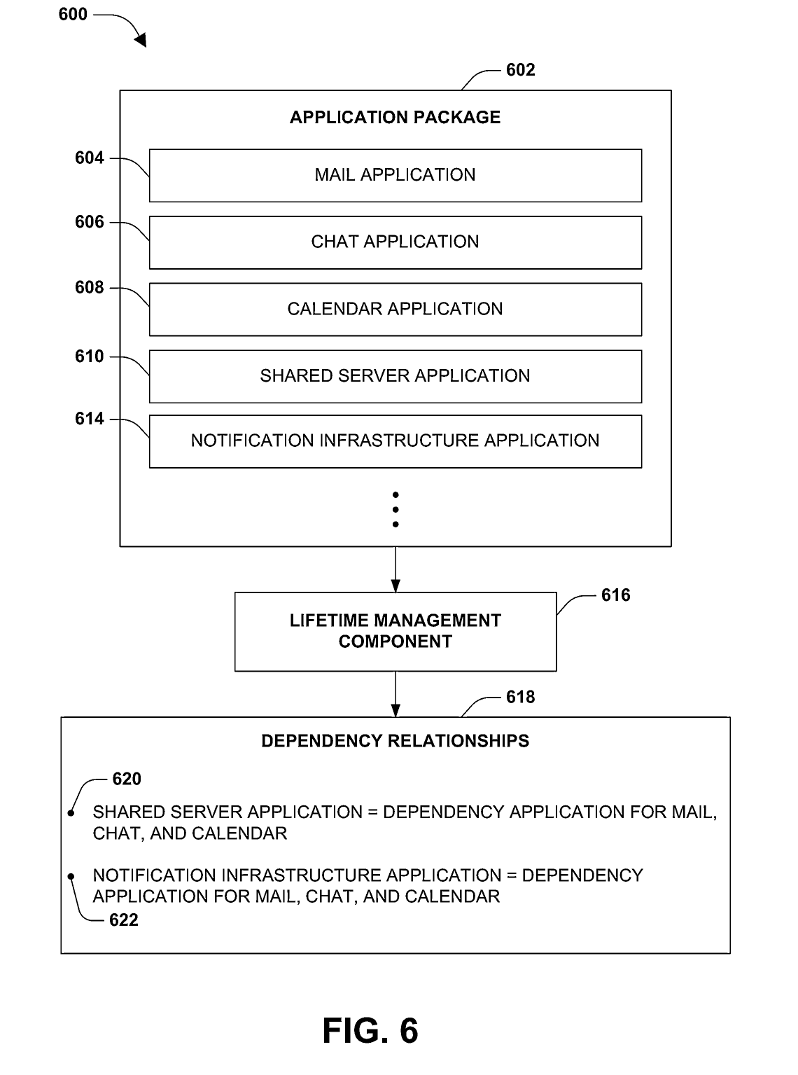

FIG. 6 illustrates an example of a system 600 for managing dependencies between a set of applications within an application package 602 during lifetime management of the set of applications. The application package 602, such as a productivity suite, may comprise a mail application 604, a chat application 606, a calendar application 608, a shared server application 610, a notification infrastructure application 610, and/or other applications. In an example, the application package 602 may be distributed, downloaded, and/or installed as a single unit. Because lifetimes of applications within the application package 602 may be independently and/or individually managed, it may be advantageous to identify dependency relationships between applications so that lifetimes of such applications may be tied together (e.g., a lifetime of a dependency application may be maintained such that the dependency application is available to provide functionality relied upon by other applications within the application package 602).

The system 600 may comprise a lifetime management component 616. The lifetime management component 616 may be configured to identify dependency relationships 618 between applications within the application package 602. For example, the lifetime management component 616 may determine that the shared server application 610 is a dependency application for the mail application 604, the chat application 606, and/or the calendar application 608 based upon the shared server application 610 providing storage functionality for such applications. In this way, the lifetime management component 616 may create a first set of dependency relationships 620 for the shared server application 610. The lifetime management component 616 may determine that the notification infrastructure application 614 may be a dependency application for the mail application 604, the chat application 606, and/or the calendar application 608 based upon the notification infrastructure application 614 providing notification functionality for such applications (e.g., new mail notifications, new message notifications, calendar event notifications, etc.). In this way, the lifetime management component 616 may create a second set of dependency relationships 622 for the notification infrastructure application 614.

The lifetime management component 616 may individually and/or independently manage lifetimes of the mail application 604, the chat application 606, and/or the calendar application 608 based upon such applications not providing functionality relied upon by other applications (e.g., the calendar application 608 may be suspended due to inactivity by a user, while the chat application 608 is maintained in an execution state based upon user interactive with the chat application 608). The lifetime management component 616 may manage a lifetime of the shared server application 610 and/or a lifetime of the notification infrastructure application 614 based upon lifetimes of the mail application 604, the chat application 606, and/or the calendar application 608 (e.g., if at least one of the mail, chat, or calendar application is executing, then the shared server application 610 and/or the notification infrastructure application 614 may be executed).

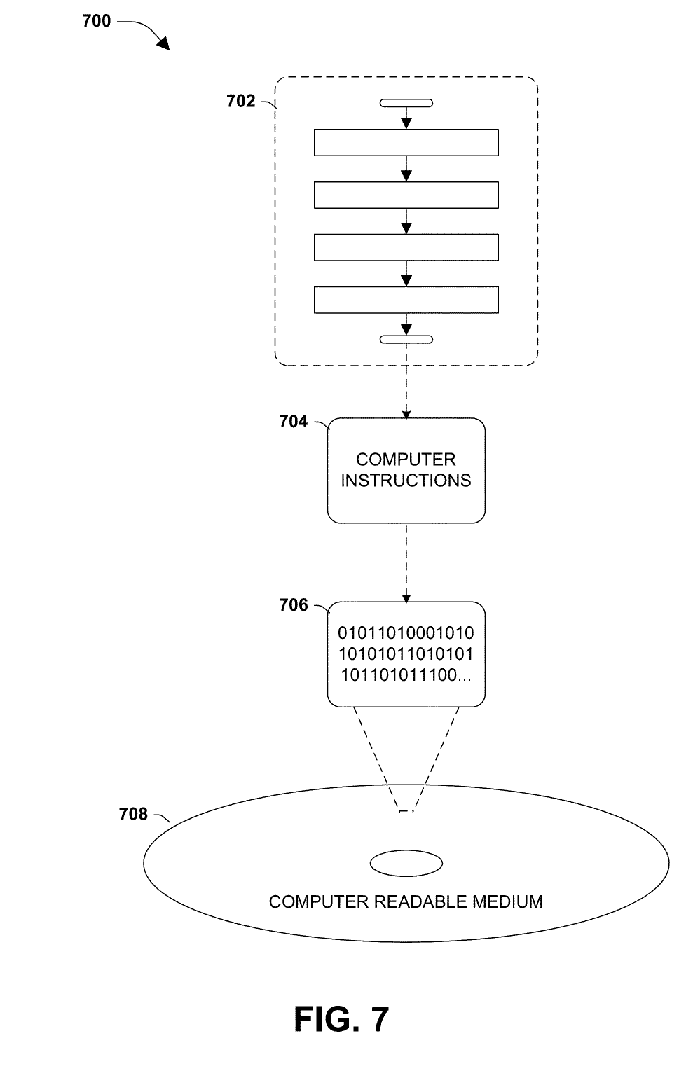

Still another embodiment involves a computer-readable medium comprising processor-executable instructions configured to implement one or more of the techniques presented herein. An example embodiment of a computer-readable medium or a computer-readable device that is devised in these ways is illustrated in FIG. 7, wherein the implementation 700 comprises a computer-readable medium 708, such as a CD-R, DVD-R, flash drive, a platter of a hard disk drive, etc., on which is encoded computer-readable data 706. This computer-readable data 706, such as binary data comprising at least one of a zero or a one, in turn comprises a set of computer instructions 704 configured to operate according to one or more of the principles set forth herein. In some embodiments, the processor-executable computer instructions 704 are configured to perform a method 702, such as at least some of the exemplary method 100 of FIG. 1 and/or at least some of the exemplary method 500 of FIG. 5, for example. In some embodiments, the processor-executable instructions 704 are configured to implement a system, such as at least some of the exemplary system 200 of FIG. 2, at least some of the exemplary system 400 of FIG. 4, and/or at least some of the exemplary system 600 of FIG. 6, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

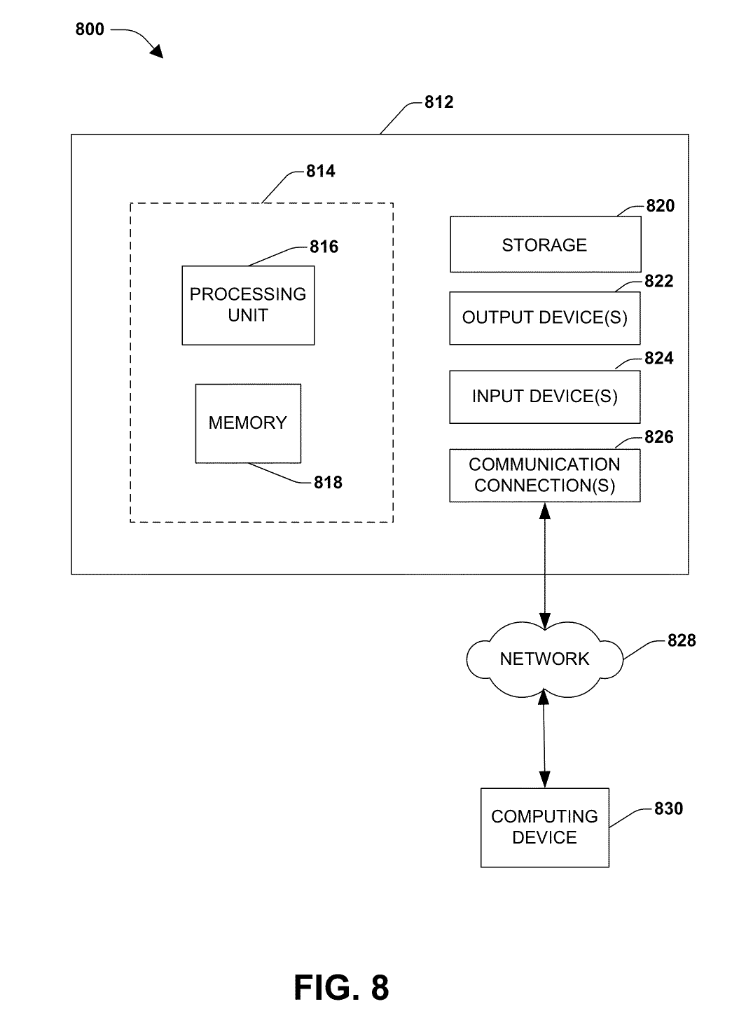

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 800 comprising a computing device 812 configured to implement one or more embodiments provided herein. In one configuration, computing device 812 includes at least one processing unit 816 and memory 818. Depending on the exact configuration and type of computing device, memory 818 may be volatile (such as RAM, for example), non-volatile (such as ROM, flash memory, etc., for example) or some combination of the two. This configuration is illustrated in FIG. 8 by dashed line 814.

In other embodiments, device 812 may include additional features and/or functionality. For example, device 812 may also include additional storage (e.g., removable and/or non-removable) including, but not limited to, magnetic storage, optical storage, and the like. Such additional storage is illustrated in FIG. 8 by storage 820. In one embodiment, computer readable instructions to implement one or more embodiments provided herein may be in storage 820. Storage 820 may also store other computer readable instructions to implement an operating system, an application program, and the like. Computer readable instructions may be loaded in memory 818 for execution by processing unit 816, for example.

The term “computer readable media” as used herein includes computer storage media. Computer storage media includes volatile and nonvolatile, removable and non-removable media implemented in any method or technology for storage of information such as computer readable instructions or other data. Memory 818 and storage 820 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 812. Any such computer storage media may be part of device 812.

Device 812 may also include communication connection(s) 826 that allows device 812 to communicate with other devices. Communication connection(s) 826 may include, but is not limited to, a modem, a Network Interface Card (NIC), an integrated network interface, a radio frequency transmitter/receiver, an infrared port, a USB connection, or other interfaces for connecting computing device 812 to other computing devices. Communication connection(s) 826 may include a wired connection or a wireless connection. Communication connection(s) 826 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 812 may include input device(s) 824 such as keyboard, mouse, pen, voice input device, touch input device, infrared cameras, video input devices, and/or any other input device. Output device(s) 822 such as one or more displays, speakers, printers, and/or any other output device may also be included in device 812. Input device(s) 824 and output device(s) 822 may be connected to device 812 via a wired connection, wireless connection, or any combination thereof. In one embodiment, an input device or an output device from another computing device may be used as input device(s) 824 or output device(s) 822 for computing device 812.

Components of computing device 812 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 812 may be interconnected by a network. For example, memory 818 may be comprised of multiple physical memory units located in different physical locations interconnected by a network.

Those skilled in the art will realize that storage devices utilized to store computer readable instructions may be distributed across a network. For example, a computing device 830 accessible via a network 828 may store computer readable instructions to implement one or more embodiments provided herein. Computing device 812 may access computing device 830 and download a part or all of the computer readable instructions for execution. Alternatively, computing device 812 may download pieces of the computer readable instructions, as needed, or some instructions may be executed at computing device 812 and some at computing device 830.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application.

What is claimed is:

1. A method for facilitating lifetime management of a dynamically created child application, comprising:
dynamically creating a child application during execution of a parent application; and
instructing a lifetime management component to manage a child lifetime of the child application independently from lifetimes of applications with which the child application does not have a dependency relationship.

2. The method of claim 1, comprising:
responsive to the parent application transitioning into an inactive state, independently managing the child application from the parent application while the parent application is in the inactive state.

3. The method of claim 1, comprising:
specifying that the child application has a first dependency relationship with a first application; and
instructing the lifetime management component to manage the child lifetime of the child application according to a first lifetime of the first application based upon the first dependency relationship.

4. The method of claim 3, comprising at least one of:
initializing the child application based upon initialization of the first application;
executing the child application based upon execution of the first application;
suspending the child application based upon suspension of the first application;
terminating the child application based upon termination of the first application;
initializing the first application based upon initialization of the child application;
executing the first application based upon execution of the child application;
suspending the first application based upon suspension of the child application; or
terminating the first application based upon termination of the child application.

5. The method of claim 1, comprising:
dynamically creating a second child application during execution of the parent application; and
instructing the lifetime management component to manage a second child lifetime of the second child application independently from at least one of the child lifetime of the child application or a parent lifetime of the parent application.

6. The method of claim 3, comprising:
maintaining a dependency graph specifying one or more dependencies between applications; and
creating a new dependency within the dependency graph based upon the first dependency relationship.

7. The method of claim 6, the creating a new dependency comprising:
dynamically creating the new dependency during execution of the first application.

8. The method of claim 1, comprising:
responsive to identifying a communication between an application and one or more child applications while the one or more child application are in a suspended state, transitioning at least some of the one or more child applications from the suspended state to an execution state for the communication with the application.

9. A method for managing dependencies between a set of applications of an application package during lifetime management of the set of applications, comprising:
identifying an application package comprising a set of applications;
identifying a dependency application within the set of applications that is depended upon by a first application within the set of applications;
defining a first dependency relationship between the dependency application and the first application;
independently managing lifetimes of respective applications, not associated with a dependency relationship, within the set of applications; and
managing a dependency lifetime of the dependency application according to a first lifetime of the first application based upon the first dependency relationship.

10. The method of claim 9, the identifying a dependency application comprising:
identifying the dependency application based upon the dependency application being a shared server for the first application.

11. The method of claim 9, the identifying a dependency application comprising:
identifying the dependency application based upon the dependency application corresponding to an infrastructure component.

12. The method of claim 9, the identifying a dependency application comprising:
identifying the dependency application based upon at least one of the dependency application not corresponding to a user interface or a dependency application declaration within the application package.

13. The method of claim 9, the identifying a dependency application comprising:
identifying the dependency application based upon a service provided by the dependency application for the first application.

14. The method of claim 9, comprising:
defining a second dependency relationship between the dependency application and a second application within the set of applications based upon the second application depending upon the dependency application;
managing the dependency lifetime of the dependency application according to a second lifetime of the second application based upon the second dependency relationship.

15. The method of claim 9, comprising:
maintaining a dependency graph specifying one or more dependencies between applications within the set of applications; and
creating a new dependency within the dependency graph based upon the first dependency relationship.

16. The method of claim 9, a second application within the set of applications not having a dependency relationship with a third application within the set of applications, and the independently managing lifetimes of respective applications comprising:
transitioning the second application into a suspended state based upon detecting a lack of interaction with the second application; and
maintaining the third application in an execution state while the second application is in the suspended state based upon detecting interaction with the third application.

17. A system for facilitating lifetime management of a dynamically created child application, comprising:
a lifetime management component configured to:
identify a dynamically created child application created by a parent application during execution of the parent application; and
manage a child lifetime of the child application independently from lifetimes of applications with which the child application does not have a dependency relationship.

18. The system of claim 17, the lifetime management component configured to at least one of:
responsive to the parent application transitioning into an inactive state, independently manage the child application from the parent application while the parent application is in the inactive state, or
receive a state transition direction from the parent application, the state transition direction specifying a state into which the child application is to be transitioned, and transition the child application into the state based upon the state transition direction.

19. The system of claim 17, the lifetime management component configured to:
determine that the child application has a first dependency relationship with a first application; and
manage the child lifetime of the child application according to a first lifetime of the first application based upon the first dependency relationship.

20. The system of claim 17, the lifetime management component configured to:
responsive to identifying a communication between an application and the child application while the child application is in a suspended state, transition the child application from the suspended state to an execution state for the communication with the application.
